(19) United States
(12) Patent Application Publication
(10) Pub. No.: US 2020/0064482 A1
(43) Pub. Date: Feb. 27, 2020

(54) LIDAR USING NEGATIVE CORRELATION

(71) Applicant: KOREA ADVANCED INSTITUTE OF SCIENCE AND TECHNOLOGY, Daejeon (KR)

(72) Inventors: Chang-Hee LEE, Daejeon (KR); Il-Pyeong HWANG, Daejeon (KR); Myeonggyun KYE, Daejeon (KR); YongJun JEONG, Daejeon (KR); Jongwan KIM, Daejeon (KR); Kwanyong LEE, Daejeon (KR); SeokJun YUN, Daejeon (KR)

(21) Appl. No.: 16/547,010

(22) Filed: Aug. 21, 2019

(30) Foreign Application Priority Data
Aug. 21, 2018 (KR) 10-2018-0097513

(51) Int. Cl. G01S 17/93; G01S 7/487

(52) U.S. Cl. CPC G01S 17/936; G01S 2007/4975; G01S 7/4873

(57) ABSTRACT

The present invention provides a LIDAR 100 including a correlation signal generation unit 110 for generating two or more different correlation signals, a signal transmission/reception unit 130 for outputting a part of the two or more correlation signals as a transmission signal St, and receive a signal returned by reflecting from a target 140 among the output transmission signals St as a received signal Sr, a delay time adjustment unit 150 for delaying a reference signal by an appropriate delay time using the reference signal Sref, and a delay time decision unit 180 for determining whether a signal obtained by adding the received signal and the delay reference signal together has an SNR higher than a threshold, thus to determine whether the delay time delayed by the delay time adjustment unit 150 is appropriate or not, and a processing unit 190 for confirming characteristics of the target 140.

### CROSS-REFERENCE TO RELATED APPLICATIONS

This application claims priority to Korean Patent Application No. 10-2018-0097513, filed on Aug. 21, 2018 in the Korean Intellectual Property Office, the entire disclosure of which is incorporated herein by reference.

### BACKGROUND OF THE INVENTION

### 1. Field of the Invention

The present invention relates to a decorrelated LIDAR using negative correlation signals or signals having a negative correlation therebetween.

### 2. Description of the Related Art

Light detection and ranging (LIDAR) devices are configured to confirm characteristics (a distance between the LIDAR device and a target to be measured, a shape of the target, and a three-dimensional image of the target, etc.) of the measurement target from a time in which a laser beam emitted from a light source is returned by scattering or reflecting from the target, changes in the intensity, frequency, and polarization state thereof, and have higher measurement accuracy than the radars, cameras, and image sensors. Therefore, the LIDAR device is recognized as an essential device in an autonomous driving system. In response to such a demand, a LIDAR device (hereinafter briefly referred to as a “LIDAR”) which may be mounted on a vehicle capable of quickly observing environments around the vehicle has recently been introduced in the market, and is expected to grow exponentially with the development of autonomous driving techniques.

Meanwhile, currently commercially available LIDAR systems have a problem that the LIDARs interfere with each other. Therefore, when a plurality of LIDARs in operation are present within a measurement area, serious measurement errors may occur due to the interference between the LIDARs, and thereby causing an accident. In addition, since measures against physical hacking are not provided in the conventional LIDARs, there is a possibility to be abused such as terrorism using hacking.

As measures to cope with such a problem, LIDAR systems using a method of measuring a correlation between a transmission signal and a received signal have been known in the art. As an example among these systems, a method, which includes generating pseudo-random bit strings, transmitting signals modulated into different bit patterns for each pulse, storing the modulation patterns, and conforming an orthogonality between the transmission signal and the received signal returned by reflecting from the target to avoid the mutual interference, has been known in the art (see Non-Patent Document 1).

However, since the method of Non-Patent Document 1 does not use a complete random bit, there is room for an interference between pulses, and a hacker may find the modulation pattern.

Further, unlike Non-Patent Document 1, a method, which includes transmitting and storing outputs of a chaotic laser which are difficult to predict by using a chaotic state of laser beams, and conforming a correlation between the output and the received signal returned by reflecting from the target, so as to avoid the interference therebetween and suppress hacking, has been known in the art (see Non-Patent Document 2).

However, the method of Non-Patent Document 2 is not practical because the system is very unstable.

Furthermore, in order to confirm the cross-correlation between the stored signal and the received signal, these conventional methods require a process of digitizing both signals and calculating a correlation therebetween using a processor. As conventional methods for obtaining a correlation between both signals, there are a method for obtaining the correlation in a time domain of a signal and a method for obtaining the correlation in a frequency domain of the signal, which has complexity of calculation lower than that of the former method, therefore the latter method is preferred. However, in the currently known LIDARs, 10,000 or more samples are required to measure objects at a distance of 200 m (with high angular resolution). Thereby, in order to confirm the correlation between the signals, a lot of calculation time is required.

In particular, in a LIDAR of a scanning method, which is used in an autonomous vehicle, etc., since it is necessary to form point cloud data consisting of a very large number of pixels in order to recognize an object, faster measurement is required than before. Therefore, it is difficult for the conventional method to be applied to an application field in which an object such as an autonomous vehicle needs to be quickly recognized and coped with.

Meanwhile, in order to improve a reception sensitivity of the LIDAR, it is preferable to use a coherent detection method. The coherent detection method can receive a signal only when polarizations between the received signal and the local oscillator coincide with each other. In this regard, this method is sensitive to whether the polarizations therebetween coincide with each other. In addition, the polarization in the received signal of the LIDAR may be changed depending on the state of a surface of the target or substances located within a moving path of light. Therefore, methods of measuring a change in the polarization to analyze features of the target surface, characteristics and density of a medium between the LIDAR and the target, and the like are known in the art. These methods employ a method of transmitting a polarization signal (e.g., an x polarization signal) to analyze a change in an intensity ratio of two polarization components (i.e., an x polarization component and a y polarization component) of the received signal over time. However, this method may also cause serious errors in the measurement results due to the above-described interference problem between the LIDARs.

### PRIOR ART DOCUMENT

### Non-Patent Document

(Non-Patent Document 1) Fan-Yi Lin and Jia-Ming Liu, Chaotic LIDAR, IEEE JOURNAL OF SELECTED TOPICS IN QUANTUM ELECTRONICS, VOL. 10, NO. 5, SEPTEMBER/OCTOBER 2004.
(Non-Patent Document 2) N. Takeuchi, N. Sugimoto, H. Baba, and K. Sakurai, Random modulation cw LIDAR, APPLIED OPTICS, Vol. 22, No. 9, 1 May 1983.

### SUMMARY OF THE INVENTION

In consideration of the above-mentioned circumstances, it is an object of the present invention to provide a LIDAR capable of solving the interference problem between LIDARs, enhancing a security by lowering the possibility of hacking, and measuring correlation ten times faster (several tens of microseconds) than the conventional method by means of a simple hardware configuration without an additional high-speed calculation device.

In addition, another object of the present invention is to provide a LIDAR capable of performing coherent detection so as to more sensitively receive a signal returned by reflecting from a target, analyzing polarization information of the received signal without interference with other signals, and rapidly measuring a correlation between a transmission signal and the received signal as the above-described characteristics.

In order to achieve the above objects, according to an aspect of the present invention, there is provided a LIDAR using negative correlation signals, including: a correlation signal generation unit configured to generate two or more negative correlation signals; a signal transmission/reception unit configured to output a part of the two or more negative correlation signals to an atmosphere as a transmission signal, and receive a signal returned by reflecting from a target among the output transmission signals as a received signal; and a processing unit configured to confirm characteristics of the target using the received signal and a reference signal, wherein the remaining correlation signal of the two or more signals other than the transmission signal is used as the reference signal.

According to another aspect of the present invention, there is provided a LIDAR using negative correlation signals, including: a correlation signal generation unit configured to generate two or more different negative correlation signals; a local oscillator configured to generate polarization components in two different directions; a signal transmission/reception unit configured to output a part of the two or more negative correlation signals to an atmosphere as a transmission signal, and receive a signal returned by reflecting from a target among the output transmission signals as a received signal; a first polarization beam splitter configured to divide the polarization components in two directions generated by the local oscillator into a polarization component in an X direction and a polarization component in a Y direction; a second polarization beam splitter configured to divide the received signal into a polarization component in the X direction and a polarization component in the Y direction; and a processing unit configured to confirm characteristics of the target using detection signals, which are detected from the polarization components in the X direction and the Y direction respectively divided by the first polarization beam splitter and the second polarization beam splitter, and a reference signal, wherein the remaining correlation signal of the two or more signals other than the transmission signal is used as the reference signal.

The conventional LIDARs without mutual interference between the LIDAR signals are not suitable for autonomous vehicles that need to quickly search environments because they take a lot of time to calculate the correlation therebetween. On the other hand, according to the present invention having the above-described configuration, it is possible to provide a LIDAR which has no mutual interference between the LIDAR signals and may quickly measure the correlation between the transmission and received signals without a separate calculation device.

In addition, since random signals without correlation between the transmission signals are used at every measurement time, there is no interference between the measurements.

Further, according to the present invention having the above-described configuration, it is possible to provide a LIDAR capable of performing coherent detection regardless of the polarization of the received signal returned by reflecting from the target.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a configuration of a LIDAR according to preferred Embodiment 1 of the present invention;

FIG. 2 is a diagram illustrating a configuration of a correlation signal generation unit illustrated in FIG. 1;

FIG. 3 is graphs illustrating characteristics of outputs from the correlation signal generation unit;

FIG. 4 is a diagram illustrating an example for implementing a delay time adjustment unit illustrated in FIG. 1 as an electronic device;

FIG. 5 is graphs illustrating a principle of implementing the delay time decision unit illustrated in FIG. 1;

FIG. 6 is a graph illustrating results of correlation restoration by the LIDAR of Embodiment 1; and

FIG. 7 is a diagram illustrating a configuration of a LIDAR according to preferred Embodiment 2 of the present invention.

### DETAILED DESCRIPTION OF THE INVENTION

Hereinafter, preferred embodiments of the present invention will be described in detail with reference to the accompanying drawings.

### Embodiment 1

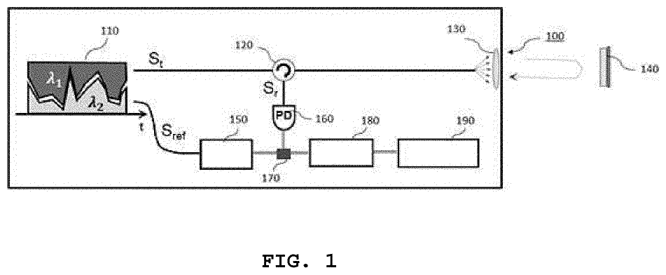

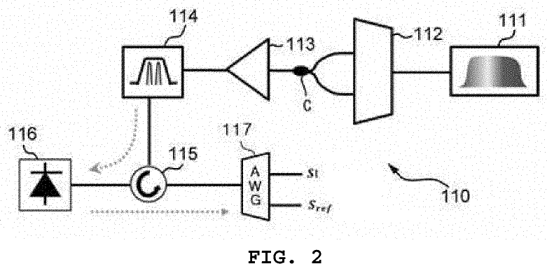

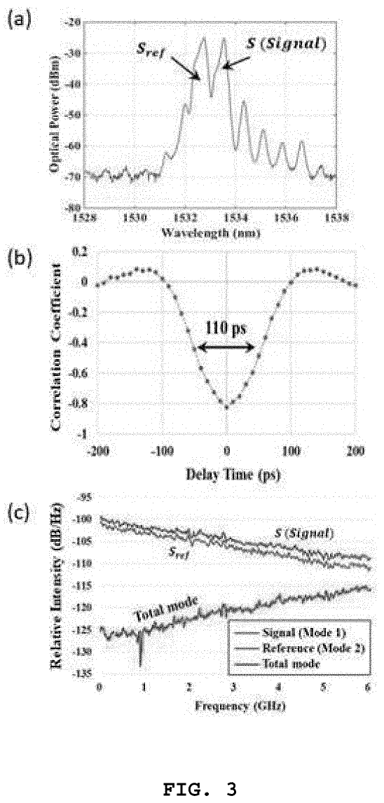

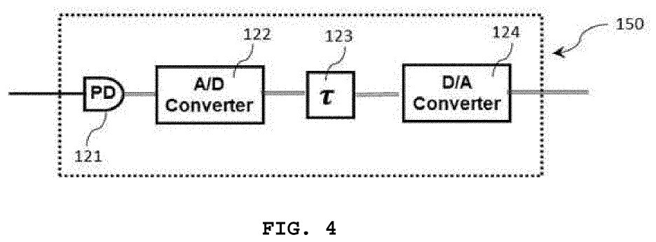

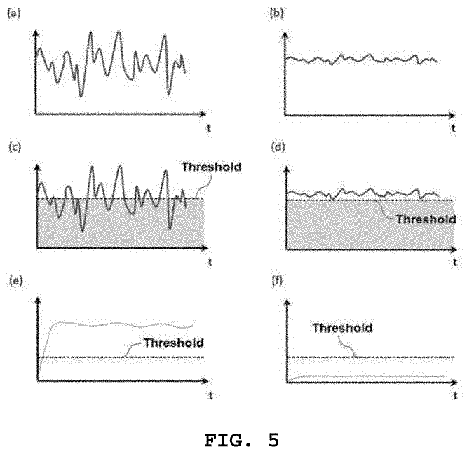

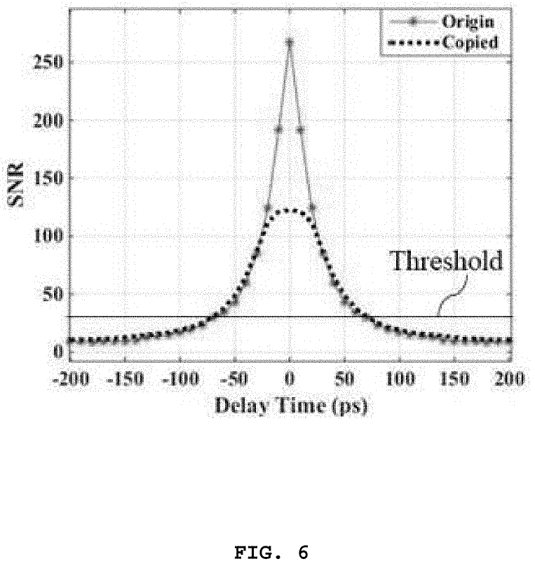

First, preferred Embodiment 1 of the present invention will be described with reference to FIGS. 1 to 6. FIG. 1 is a diagram illustrating a configuration of a LIDAR according to preferred Embodiment 1 of the present invention, FIG. 2 is a diagram illustrating a configuration of a correlation signal generation unit illustrated in FIG. 1, FIG. 3 is graphs illustrating characteristics of outputs from the correlation signal generation unit, FIG. 4 is a diagram illustrating an example for implementing a delay time adjustment unit illustrated in FIG. 1 as an electronic device, FIG. 5 is graphs illustrating a principle of implementing the delay time decision unit illustrated in FIG. 1, and FIG. 6 is a graph illustrating results of correlation restoration by the LIDAR of Embodiment 1.

As illustrated in FIG. 1, a LIDAR 100 according to preferred Embodiment 1 of the present invention includes a correlation signal generation unit 110 which generates a negative correlation (i.e., inverse correlation) signal, an optical circulator 120, a signal transmission/reception unit 130, a delay time adjustment unit (briefly, a delay unit) sheath 150, a photodetector 160, an electric signal combiner 170, a delay time decision unit 180, and a processing unit 190. The components from the correlation signal generation unit 110 to the photodetector 160 are optically connected with each other by optical fiber cables, and the components from output terminals of the delay time adjustment unit 150 and the photodetector 160 to the processing unit 190 are electrically connected with each other by cables for an electric signal.

The correlation signal generation unit 110 generates two signals having different wavelengths from each other. At this time, one of the two generated signals is used as a reference signal Sref and the other is used as a transmission signal St.

A specific configuration of the correlation signal generation unit 110 according to Embodiment 1 of the present invention will be described.

As illustrated in FIG. 2, the correlation signal generation unit 110 includes a broadband light source (BLS) 111, an arrayed waveguide grating (AWG) 112, an optical coupler C, an erbium doped fiber amplifier (EDFA) 113, a band pass filter 114, an optical circulator 115, a Fabry-Perot laser diode 116, and an arrayed waveguide grating 117. These components are optically connected with each other by the optical fiber cables.

The broadband light source 111 is a light source that emits a light having a relatively wide wavelength band compared to a general light source, and is a light source for generating a correlation signal of the present invention.

The light (signal) emitted from the broadband light source 111 is divided into lights having two wavelength bands λ1 and λ2 in the arrayed waveguide grating 112. The divided lights having two wavelength bands become signals having negative correlation (i.e., negative correlation signals) of the present invention, that is, the reference signal Sref and the transmission signal St.

The lights having two wavelength bands divided in the arrayed waveguide grating 112 are combined by the optical coupler C, and then amplified by an amplifier such as the erbium doped fiber amplifier 113, for example. Thereafter, an additional noise signal is removed while the lights pass through the band pass filter 114, and then introduced into the Fabry-Perot laser diode 116 through the optical circulator 115. At this time, a channel spacing between the lights having two wavelength bands introduced into the Fabry-Perot laser diode 116 coincides with a mode spacing of the Fabry-Perot laser diode 116.

As described above, the correlation signal generation unit 110 of the present embodiment amplifies intensities of the lights of the two channels using the erbium-doped fiber amplifier 113, and then introduces the amplified lights into the Fabry-Perot laser diode 116, so as to form a negative correlation between the intensities of two lights (signals) using a strong gain saturation phenomenon of the Fabry-Perot laser diode 116.

Two signals having the negative correlation formed by the Fabry-Perot laser diode 116 are transmitted to the arrayed waveguide grating 117 through the optical circulator 115. These signals are divided into the reference signal Sref and the transmission signal St in the arrayed waveguide grating 117, respectively, and then output.

FIG. 3A illustrates optical spectra of the correlation signals output from the correlation signal generation unit 110. Preferably, a signal with a larger intensity of the signals having two wavelengths output from the correlation signal generation unit 110 is used as the reference signal Sref, and a signal with a smaller intensity is used as the transmission signal St. But, it is not limited thereto, and these signals may be used the opposite.

FIG. 3B is a graph illustrating results of confirming negative cross-correlation present between the two signals output from the correlation signal generation unit 110, that is, between the reference signal Sref and the transmission signal St. A correlation time between the reference signal Sref and the transmission signal St is about 110 ps.

The ideal negative correlation signal mentioned in the present invention is a signal in which, when two different signals are added together, the respective oscillating lights cancel each other out such that only a DC component appears. In the present invention, when the transmission signal St is added with the reference signal Sref obtained by delaying the received signal Sr which is a signal returned by scattering or reflecting (hereinafter simply referred to as “reflecting”) from an object to be described below for an appropriate time, a signal having a DC component of a predetermined magnitude or more (having a very high signal to noise ratio (SNR)) is measured. Thereby, it can be confirmed that there is a negative correlation between the received signal and the reference signal. At this time, characteristics of the object, i.e., a target including a distance between the LIDAR and the target, for example, may be identified using the delay time.

Herein, the SNR higher than the predetermined magnitude may be set to an appropriate value as necessary, in consideration of the accuracy of measurement required by the LIDAR and the like.

Hereinafter, the term “characteristic of the target” as used herein inclusively means a distance between the LIDAR and the target, a shape of the target, and a three-dimensional image of the target.

At this time, when the received signal is a signal sent from another LIDAR other than its own LIDAR, such a negative correlation cannot be obtained between the reference signal Sref and the interference signal Sint. Therefore, interference between signals received from other LIDARs is automatically canceled out. In addition, even when a hacker receives a signal sent from the LIDAR and sends it by amplifying, the hacker cannot make a ghost object in front of his/her own position, such that a part of the hacking may be prevented.

In the above-described example, the case, in which the delay time applied to the reference signal Sref is variably applied, has been described. However, a case, in which a fixed delay time is given to the reference signal Sref and a variable delay time is applied to the received signal Sr, is also possible, which is applicable to all the other embodiments or modifications to be described below.

FIG. 3C is a graph illustrating results of measuring relative noise intensities of the reference signal Sref output from the correlation signal generation unit 110, the transmission signal St, and a case of adding these two signals together, and comparing with each other. Each of the reference signal Sref and the transmission signal St shows a very large noise intensity, but a signal obtained by adding these two signals together without a difference in a path delay (a total mode) shows a very low noise intensity. In the present embodiment, a difference of about 18 dB is shown between these signals and the total mode.

Referring again to FIG. 1, the optical circulator 120 changes a transmission direction of the transmission signal St. Specifically, the transmission signal St generated from the correlation signal generation unit 110 is transmitted to the signal transmission/reception unit 130, and output to an atmosphere from the signal transmission/reception unit 130. Then, the received signal Sr returned to the signal transmission/reception unit 130 by reflecting from a target 140 is transmitted to the photodetector 160 while changing the transmission direction thereof.

The signal transmission/reception unit 130 outputs the transmission signal St sent from the optical circulator 120 to the atmosphere, receives the signal returned by reflecting from the target 140 among the output transmission signals St, and transmits the received signal to the optical circulator 120.

The target 140 is the object to be measured by the LIDAR 100 of the present invention. For example, when the LIDAR 100 of the present invention is applied to an unmanned autonomous vehicle, the target 140 may be a fixed target, a moving target, or the like located on the traveling path of the unmanned autonomous vehicle. The transmission signal St output to the atmosphere from the signal transmission/reception unit 130 is returned to the signal transmission/reception unit 130 by reflecting from the target 140.

The delay time adjustment unit 150 is a device for delaying the reference signal Sref generated from the correlation signal generation unit 110 for an appropriate delay time, and transmits the reference signal Sref delayed by the delay time toward the electric signal combiner 170. Herein, the delay time is variable, and may be appropriately adjusted as necessary.

The photodetector 160 converts an optical received signal sent from the optical circulator 120 into an electric signal, and transmits the converted electric signal to the electric signal combiner 170.

The electric signal combiner 170 combines the reference signal Sref delayed by the predetermined delay time with the received signal Sr, and transmits the combined signal to the delay time decision unit 180.

The delay time decision unit 180 determines whether the electric signal sent from the photodetector 160 has an SNR higher than the predetermined magnitude, that is, whether the reference signal delayed by the delay time adjustment unit 150 and the electric signal of the received signal Sr sent from the photodetector 160 have a negative correlation with each other. At this time, when it is confirmed that the signal has an SNR higher than the predetermined magnitude, the delay time decision unit 180 determines that the reference signal Sref is delayed by the delay time adjustment unit 150 by the appropriate delay time, and transmits the result thereof to the processing unit 190.

When receiving a determination signal which is a signal indicating that an appropriate delay time is set from the delay time decision unit 180, the processing unit 190 confirms characteristics of the target such as the distance to the target 140 using the delay time, and outputs the result thereof to the outside in a visual or auditory manner as necessary.

When confirming the distance between the LIDAR 100 and the target 140 among the characteristics of the target, for example, the processing unit 190 calculates the distance to the target 140 using the reference signal Sref and the received signal Sr which is returned to the signal transmission/reception unit 130 by reflecting from the target 140. Specifically, the delay time decision unit 180 determines whether the reference signal Sref and the received signal Sr which are combined to one optical signal by the electric signal combiner 170 have an SNR higher than an predetermined reference value, respectively. If it is determined that the reference signal Sref and the received signal Sr have an SNR higher than the predetermined reference value, respectively, the delay time decision unit 180 transmits a determination signal to the processing unit 190, which is a signal indicating that the appropriate delay time is set. At that point, the processing unit 190 calculates a distance D between the LIDAR 100 and the target 140 using a delay time value Δt representing the time in which the reference signal Sref is delayed by the delay time adjustment unit 150 by means of Equation 1 below.

D=(Δt×c)/2 [Equation 1]

Wherein, c denotes a speed of light.

Next, an example of implementing the delay time adjustment unit 150 according to preferred Embodiment 1 of the present invention will be described.

First, an example of implementing the delay time adjustment unit 150 using electronic devices will be described with reference to FIG. 4. The delay time adjustment unit 150 includes a photodetector 121, an analog-to-digital converter 122, a time delay unit 123, and a digital-to-analog converter 124. All of these components are connected by cables for an electric signal. An input to the delay time adjustment unit 150 is an optical signal, and an output therefrom is an electric signal.

The photodetector 121 converts the optical signal input to the delay time adjustment unit 150 into an electric signal, and transmits the converted electric signal to the analog-to-digital converter 122.

The analog-to-digital converter 122 samples the analog signal received from the photodetector 121, converts the sampled analog signal into a digital signal, and transmits the converted digital signal to the time delay unit 123.

The time delay unit 123 delays the digital data received from the analog-to-digital converter 122 by a necessary time (in practice, changes the delay time sequentially), and then transmits the delayed signal to the digital-to-analog converter 124.

The digital-to-analog converter 124 converts the digital signal received from the analog-to-digital converter 122 through the time delay unit 123 into an analog signal to output the converted analog signal.

An example of the delay time adjustment unit 150 described in FIG. 4 uses a method of converting an input optical signal into an electric signal, sampling and storing the same in a memory, delaying it for a predetermined time, then converting the delayed digital signal into an analog signal to output the converted analog signal.

However, the delay time adjustment unit 150 is not limited to the example illustrated in FIG. 4. In addition to the method of FIG. 4, the delay time adjustment unit 150 may be formed by using, for example, a variable optical delay line that can manually or automatically control the delay time.

Next, the principle of implementing the delay time decision unit 180 according to Embodiment 1 of the present invention will be described with reference to FIG. 5.

First, if the delay time of the reference signal Sref delayed by the delay time adjustment unit 150 is not appropriate, a signal obtained by adding the reference signal Sref and the received signal Sr together will appear as a severely oscillating signal, that is, a signal having a very low SNR, as illustrated in FIG. 5A. On the other hand, when the delay time of the reference signal Sref delayed by the delay time adjustment unit 150 is appropriate, a signal obtained by adding the reference signal Sref and the received signal Sr together will appear as a signal with little oscillation, that is, a signal having a very high SNR, as illustrated in FIG. 5B. In this case, it may be said that the reference signal Sref and the received signal Sr have a negative correlation with each other.

In the above two cases, there are a plurality of methods for confirming whether the delay time of the reference signal Sref delayed by the delay time adjustment unit 150 is appropriate or not, and various hardware configurations for implementing the same. Hereinafter, the method will be described based on the principle.

If the delay time is not appropriate, a sum of the reference signal Sref and the received signal Sr has a low SNR and an AC component (oscillating signal), that is, power, which is a similar level to the DC component. On the other hand, when the delay time is appropriate, the sum of these signals has a high SNR and an AC component (oscillating signal), that is, power, which is much lower (about 18 dB) than the DC component. Therefore, when a point at which the AC component is appropriately lowered is confirmed, the delay time decision unit 180 may determine whether the delay time value (Δt) of the reference signal Sref delayed by the delay time adjustment unit 150 is appropriate or not.

As a method of implementing the above-described principle in hardware, there are various methods such as a method in which, first, as illustrated in FIGS. 5C and 5D, a threshold is set in advance at a point at which almost no AC component appears and only a DC component appears roughly, and then, as illustrated in FIG. 5D, by confirming a point at which the oscillating signal (the sum of the reference signal Sref and the received signal Sr) does not exceed the preset threshold (when the power of the AC component is lowered), the delay time in this case is determined as an appropriate delay time value (Δt), or a method in which, as illustrated in FIGS. 5E and 5F, the AC component of the total signal obtained by adding the reference signal Sref and the received signal Sr together is passed through a device such as a rectifier to convert the AC component into a DC component, and then, as illustrated in FIG. 5F, by confirming a point at which the magnitude of the converted DC component has a value of a reference value or a threshold or less, the delay time in this case is determined that the appropriate delay time value (Δt) is applied.

Meanwhile, the processing unit 190 confirms the correlation between the reference signal Sref and the received signal Sr for all delay times within the range that can be delayed in practice, and if the confirmed correlation is out of a predetermined range (if showing a low SNR for all delay times), determines that the received signal Sr received by the signal transmission/reception unit 130 is not the received signal in which the transmission signal St is returned by reflecting from the target 140.

Next, in order to confirm effects of the LIDAR 100 according to Embodiment 1 of the present invention, the present inventors performed an experiment such as restoration of the correlation with respect to the correlation signal, and results thereof will be described with reference to FIG. 6. FIG. 6 is a graph illustrating the restoration results of the correlation by the LIDAR of Embodiment 1.

First, a solid red line in FIG. 6 illustrates a change in the SNR according to the change in the delay time when adding the correlation signals of the two modes, that is, the reference signal Sref and the transmission signal St together. When the two signals are appropriately delayed, good results were obtained wherein the SNR of the sum of the two signals having a negative correlation (the red line in FIG. 6) far exceeded a reference value or threshold (a black straight line in FIG. 6) which can be considered to indicate that the two signals have a negative correlation with each other.

In addition, a black dotted line in FIG. 6 illustrates a change in the SNR according to the change of the delay time when the reference signal Sref among the negative correlation signals is converted into an electric signal, and is again converted into the optical signal, and then is added to the transmission signal St. When the two signals are appropriately delayed, good results were obtained wherein the SNR of the sum of the two signals having a negative correlation (the black dotted line in FIG. 6) far exceeded the reference value or the threshold (the black straight line in FIG. 6) which can be considered to indicate that the two signals have a negative correlation with each other.

Herein, the reason for having the SNR peak point (maximum value) of the black dotted line lower than that of the red solid line in FIG. 6 is that the reference signal Sref is converted into the electric signal, and is then again converted into the optical signal, such that a part of the signal is distorted during this process, and thus produces the above-described result. Using a device with better performance than the device used in the present experiment, it is expected that the difference between the above two cases will be reduced or canceled out.

Meanwhile, FIG. 6 illustrates that, if the delay time is not appropriate, both of the red solid line and the black dotted line have SNRs lower than the reference value or the threshold (the black straight line), and a negative correlation no longer appears between the reference signal Sref and the transmission signal St.

From the above results, according to the LIDAR 100 of the present embodiment, it is possible to easily confirm the correlation between the negative correlation signals, and it is easy to distinguish a signal received by the corresponding LIDAR, for example, an interference signal or a hacking signal, even when the signal is not transmitted by the LIDAR itself. Therefore, it is possible to provide a LIDAR with improved security.

### Embodiment 2

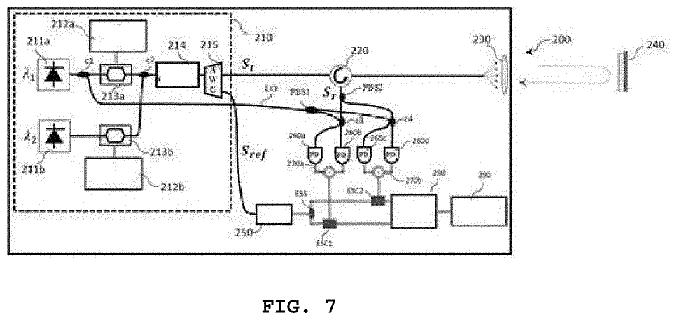

Next, preferred Embodiment 2 of the present invention will be described with reference to FIG. 7.

A LIDAR 200 according to preferred Embodiment 2 of the present invention employs a detection method for improving the reception sensitivity of the LIDAR using a so-called coherent detection method. As described above, the coherent detection method is already known in the art.

Embodiment 2 of the present invention proposes a LIDAR capable of analyzing a change in the polarization of a received signal while improving the reception sensitivity using such a conventional coherent detection method, and capable of quickly detecting the cross-correlation.

FIG. 7 is a diagram illustrating a configuration of the LIDAR according to preferred Embodiment 2 of the present invention. As illustrated in FIG. 7, the LIDAR 200 of Embodiment 2 includes a correlation signal generation unit 210, a local oscillator LO, an optical circulator 220, a signal transmission/reception unit 230, two polarization beam splitters PBS1 and PBS2, a delay time adjustment unit 250, four photodetectors 260a, 260b, 260c and 260d, two subtractors 270a and 270b, an electric signal splitter ESS, two electric signal combiners ESC1 and ESC2, a delay time decision unit 280, and a processing unit 290. Portions indicated by single solid lines between components show that the respective components are optically connected with each other by optical fiber cables, and portions indicated by double solid lines show that the respective components are electrically connected with each other by cables for an electric signal.

The correlation signal generation unit 210 generates correlation signals of two modes having different wavelengths from each other, wherein one of the two generated signals is used as a reference signal Sref, and the other is used as a transmission signal St. The correlation signal generation unit 210 includes a first light source 211a and a second light source 211b, a first signal source 212a and a second signal source 212b, a first modulator 213a and a second modulator 213b, a negative correlation generator 214, and an arrayed waveguide grating 215.

The first light source 211a and the second light source 211b are light sources that emit laser beams of wavelengths λ1 and λ2, respectively, having a narrow linewidth and a small phase noise. The light emitted from the first light source 211a is divided into two lights by an optical coupler C1, wherein one divided light is transmitted to the first modulator 213a, and the other divided light is used as a local oscillating signal of the local oscillator LO.

The first signal source 212a and the second signal source 212b are respectively a noise source for generating a correlation signal, and the first modulator 213a and the second modulator 213b modulate the intensity of light having small phase noise emitted from the two light sources 211a and 211b, respectively, by using the first signal source 212a and the second signal source 212b.

The negative correlation generator 214 functions to generate a strong gain saturation in the light to be introduced, and may use a Fabry-Perot laser diode (F-PLD) or a semiconductor optical amplifier (SOA), for example. For the signal modulated by the first modulator 213a and the second modulator 213b and introduced through an optical coupler C2, a correlation signal, in which oscillations of the signals cancel each other out by the sum of two signals while the magnitude of each signal is not largely changed by the gain saturation thus to have a high SNR, is generated. At this time, the two signals have a negative correlation, and in the ideal case, the correlation is −1.

In some cases, a negative correlation may be formed between the first light source 211a and the second light source 211b without the negative correlation generator 214. In this case, the first light source 211a applies a signal of the first signal source 212a or the second signal source 212b to the first modulator 213a to be modulated, and the second light source 211b applies a signal of −1 times that of the first signal source 212a, which is a signal obtained by modulating the light of the first light source, to the second modulator 213b to be modulated. Therefore, an output of the first modulator 213a and an output of the second modulator 213b have a negative correlation with each other.

The arrayed waveguide grating 215 divides the signal sent from the negative correlation generator 214 into the reference signal Sref and the transmission signal St. At this time, the divided reference signal Sref and the transmission signal St are transmitted to the delay time adjustment unit 250 and the optical circulator 220, respectively. In this case, it is necessary for the transmission signal St to select a signal having the same wavelength as that of the local oscillator.

The optical circulator 220 changes the transmission direction of the transmission signal St sent from the arrayed waveguide grating 215 of the correlation signal generation unit 210. That is, the transmission signal St generated from the correlation signal generation unit 210 is transmitted to the signal transmission/reception unit 230 and output to the atmosphere from the signal transmission/reception unit 230. Then, the received signal Sr returned to the signal transmission/reception unit 230 by reflecting from a target 240 is transmitted to the four photodetectors 260a, 260b, 260c and 260d via a second polarization beam splitter PBS2 and two optical couplers C3 and C4.

The signal transmission/reception unit 230 outputs the transmission signal St sent from the optical circulator 220 to the atmosphere, receives the signal reflected by the target 240 among the transmitted transmission signals St, and transmits the received signal to the optical circulator 220.

The target 240 is an object to be measured by the LIDAR 200 of the present invention. For example, when the LIDAR 200 of the present invention is applied to an unmanned autonomous vehicle, the target 240 may be a fixed target, a moving target, or the like located on the traveling path of the unmanned autonomous vehicle. The transmission signal St output to the atmosphere from the signal transmission/reception unit 230 is returned to the signal transmission/reception unit 230 by reflecting from the target 240.

The local oscillator LO generates two polarization components, for example, an X-direction polarization component and a Y-direction polarization component of the light emitted from the first light source 211a and divided by the optical coupler C1. The generated polarization components in two directions are divided by a first polarization beam splitter PBS1, and polarization component in any one direction (e.g., the X direction) of the two divided polarization components is transmitted to the optical coupler C3, and the polarization component in other direction (e.g., the Y direction) is transmitted to the optical coupler C4.

The received signal Sr received by the signal transmission/reception unit 230 is transmitted to the second polarization beam splitter PBS2 via the optical circulator 220, and the X-direction polarization component and the Y-direction polarization component of the received signal Sr are divided by the second polarization beam splitter PBS2. Thereafter, polarization component in any one direction (e.g., the X direction) of the divided X- and Y-direction polarization components is distributed to the first photodetector 260a and the second photodetector 260b from the optical coupler C3 together with the polarization component in one direction (e.g., the X direction) which is divided by the first polarization beam splitter PBS1, and the polarization component in other direction (e.g., the Y direction) is distributed to the third photodetector 260c and the fourth photodetector 260d from the optical coupler C4 together with the polarization component in other direction (e.g., the Y direction) which is divided by the first polarization beam splitter PBS1.

The first photodetector 260a and the second photodetector 260b convert the input optical signal into an electric signal, respectively, and the converted electric signals are subtracted by the first subtractor 270a. Then, in the first electric signal combiner ESC1, the subtracted electric signals are combined with one signal of the signals which are transmitted to the delay time adjustment unit 250 to be described below and distributed through the electric signal splitter ESS, and then transmitted to the delay time decision unit 280.

In addition, the third photodetector 260c and the fourth photodetector 260d also convert the input optical signal into an electric signal, respectively, and the converted electric signals are subtracted by the second subtractor 270b. Then, in the second electric signal combiner ESC2, the subtracted electric signals are combined with a signal which is transmitted through another path other than the above-described path of the signals which are transmitted to the delay time adjustment unit 250 and distributed through the electric signal splitter ESS, and then transmitted to the delay time decision unit 280.

Through the above-described subtraction process, the LIDAR 200 of the present embodiment is configured to receive a product of an optical field of the local oscillator LO and an optical field of the received signal Sr. Therefore, the intensity noise may be cancelled out, and thereby improving the reception sensitivity of the LIDAR 200.

The delay time adjustment unit 250 delays the reference signal Sref generated from the correlation signal generation unit 210 for an appropriate delay time, and converts it into an electric signal. The reference signal Sref converted into the electric signal with a delay by the appropriate delay time is divided into two signals and distributed by the electric signal splitter ESS, and the distributed two reference signals are combined with the electric signals sent from the first subtractor 270a and the second subtractor 270b by the first electric signal combiner ESC1 and the second electric signal combiner ESC2, and then transmitted to the delay time decision unit 280. The delay time in this case is variable.

The delay time decision unit 280 determines whether the signals, in which the received signals Sr received through the four photodetectors 260a, 260b, 260c and 260d, and the reference signals Sref delayed by the appropriate delay time in the delay time adjustment unit 250, then distributed to two paths through the electrical signal splitter ESS are combined with each other by the first electric signal combiner ESC1 and the second electric signal combiner ESC2, respectively, have an SNR higher than the reference value or the threshold, respectively. At this time, when it is confirmed that the signal has an SNR higher than the reference value or the threshold, the delay time decision unit 280 determines that an appropriate delay time is set in the delay time adjustment unit 250 and transmits the result thereof to the processing unit 290.

When receiving a determination signal which is a signal indicating that an appropriate delay time is set in the delay time decision unit 280, the processing unit 290 calculates a distance to the target 240, and the like using the delay time, and outputs the result thereof to the outside, as well as, analyzes a change in the polarization of the received signal relative to the transmission signal using a ratio of the correlation magnitudes of the two signals. The other calculation methods are the same as those described in Embodiment 1, and therefore the calculation method will not be described in detail in the present embodiment.

As described above, in the LIDAR 200 according to Embodiment 2 of the present invention, the second polarization beam splitter is added to the receiving end of the LIDAR 200 to perform coherent detection on the two polarization components of the X-direction polarization component and the Y-direction polarization component, respectively, and confirm the characteristics of the target such as the distance by the total signal obtained by adding the signals of the respective polarization components together. Therefore, it is possible to restore the intensity component of the light regardless of the polarization of the received signal Sr returned by reflecting from the target 240. Accordingly, unlike the conventional coherent detection method, the configuration for tracking the polarization of the received light is unnecessary in the present invention.

### Modified Embodiment

While the present invention has been described with reference to preferred Embodiments 1 and 2, the present invention is not limited to the above-described embodiments, and various alterations or modifications may be possible without departing from the scope of the present invention.

In the above Embodiments 1 and 2, the configuration, in which the reference signal Sref of an optical signal is converted into an electric signal by the delay time adjustment unit 150 or the delay time adjustment unit 250, and the converted electric signal is delayed by an appropriate delay time, then the delayed electric signal is combined with the received signal Sr converted into an electric signal by the photodetector 160 or the four photodetectors 260a, 260b, 260c and 260d, has been described, but it is not limited thereto. First, it may be configured in such a way that the reference signal Sref of an optical signal is delayed for an appropriate delay time, and then combined with the received signal Sr of an optical signal using an optical coupler, followed by converting the combined optical signal into an electric signal.

Further, in the above Embodiment 2, the configuration, in which a light of the first light source 211a that emits the laser beam having wavelength λ1 is partially divided and used as the local oscillating signal of the local oscillator LO, has been described, but it is not limited thereto. The light of the second light source 211b that emits the laser beam having wavelength λ2 may be partially divided and used as the local oscillating signal of the local oscillator LO. However, in this case, the transmission signal St output to the target 240 from the signal transmission/reception unit 230 should also use a signal in which the laser beam having wavelength λ2 is modulated by the signal source and the modulator.

Furthermore, in the above Embodiments 1 and 2, the configuration, in which the correlation signal generation unit 110 and the correlation signal generation unit 210 generate correlation signals of two modes having different wavelengths from each other, has been described, but it is not limited thereto. It may be configured in such a way that the correlation signal generation units generate correlation signals having two or more different wavelengths from each other, and a part thereof is used as the reference signal Sref and the remainder is used as the transmission signal St.

The above-described Embodiments 1 and 2 and modified embodiment may be carried out independently or in combination with each other.

### DESCRIPTION OF REFERENCE NUMERALS

100, 200: LIDAR
110, 210: Correlation signal generation unit
120, 220: Optical circulator
130, 230: Signal transmission/reception unit
150, 250: Delay time adjustment unit
180, 280: Delay time decision unit
190, 290: Processing unit

What is claimed is:

1. A LIDAR using negative correlation signals, comprising:
a correlation signal generation unit configured to generate two or more negative correlation signals;
a signal transmission/reception unit configured to output a part of the two or more negative correlation signals to an atmosphere as a transmission signal, and receive a signal returned by reflecting from a target among the output transmission signals as a received signal; and
a processing unit configured to confirm characteristics of the target using the received signal and a reference signal, wherein the remaining correlation signal of the two or more signals other than the transmission signal is used as the reference signal.

2. A LIDAR using negative correlation signals, comprising:
a correlation signal generation unit configured to generate two or more different negative correlation signals;
a local oscillator configured to generate polarization components in two different directions,
a signal transmission/reception unit configured to output a part of the two or more negative correlation signals to an atmosphere as a transmission signal, and receive a signal returned by reflecting from a target among the output transmission signals as a received signal;
a first polarization beam splitter configured to divide the polarization components in two directions generated by the local oscillator into a polarization component in an X direction and a polarization component in a Y direction;
a second polarization beam splitter configured to divide the received signal into a polarization component in the X direction and a polarization component in the Y direction; and
a processing unit configured to confirm characteristics of the target using detection signals, which are detected from the polarization components in the X direction and the Y direction respectively divided by the first polarization beam splitter and the second polarization beam splitter, and a reference signal, wherein the remaining correlation signal of the two or more signals other than the transmission signal is used as the reference signal.

3. The LIDAR according to claim 1, further comprising a decision unit configured to determine whether the received signal and a delay reference signal obtained by delaying the reference signal for a predetermined time have a negative correlation with each other,
wherein the decision unit determines that, when a signal obtained by adding the delay reference signal and the received signal together has a signal to noise ratio (SNR) higher than a predetermined magnitude, the delay reference signal and the received signal have a negative correlation with each other, and
the processing unit confirms characteristics of the target using the delay time when the delay reference signal and the received signal have the negative correlation with each other.

4. The LIDAR according to claim 2, further comprising a decision unit configured to determine whether the detection signal and a delay reference signal obtained by delaying the reference signal for a predetermined time have a negative correlation with each other,
wherein the decision unit determines that, when a signal obtained by adding the delay reference signal and the detection signal has an SNR higher than a predetermined magnitude, the delay reference signal and the detection signal have a negative correlation with each other, and
the processing unit confirms the characteristics of the target using the delay time when the delay reference signal and the detection signal have the negative correlation with each other.

5. The LIDAR according to claim 1, wherein the correlation signal generation unit comprises:
a light source,
a first optical splitting unit configured to divide a light emitted from the light source into two or more lights having different wavelengths;
an optical amplifier configured to amplify the divided two or more lights;
a Fabry-Perot laser diode configured to receive the light amplified by the optical amplifier and introduced therein, and form two or more correlation signals having a negative correlation between intensities of the two or more lights using a strong gain saturation phenomenon; and
a second optical splitting unit configured to divide the two or more correlation signals formed by the Fabry-Perot laser diode into the reference signal and the transmission signal.

6. The LIDAR according to claim 2, wherein the negative correlation signal generation unit comprises:
a first light source and a second light source configured to respectively emit laser beams having two or more different wavelengths;
a first signal source and a second signal source configured to generate signals for forming correlation signals;
a first modulator and a second modulator configured to modulate intensities of the laser beam emitted from the first light source and the signal generated by the first signal source, and the laser beam emitted from the second light source and the signal generated by the second signal source;
a negative correlation generator configured to generate a strong gain saturation in the lights modulated and introduced by the first modulator and the second modulator to generate the two or more correlation signals; and
an optical splitting unit configured to divide the two Or more correlation signals generated by the negative correlation generator into the reference signal and the transmission signal.

7. The LIDAR according to claim 6, wherein any one modulator of the first modulator and the second modulator directly modulates the signal generated by any one signal source of the first signal source and the second signal source with respect to the laser beam emitted from the light source corresponding to any one modulator of the first light source and the second light source, and the other modulator modulates the signal generated by the corresponding signal source to a value of −1 times that of the signal source with respect to the laser beam emitted from the other light source, so as to form a negative correlation between the correlation signals of the two modes.
